(19) United States
(12) Patent Application Publication
(10) Pub. No.: US 2026/0075378 A1
(43) Pub. Date: Mar. 12, 2026

(54) METHOD OF PROCESSING SIGNALS FOR SOUND REPRODUCTION

(71) Applicant: Audioscenic Limited, Southampton (GB)

(72) Inventors: Marcos Simón, Southampton (GB); Jacob Hollebon, Southampton (GB); Daniel Wallace, Southampton (GB); Yury Ushakov, Southampton (GB)

(21) Appl. No.: 19/324,712

(22) Filed: Sep. 10, 2025

(30) Foreign Application Priority Data
Sep. 12, 2024 (GB) 2413459.5

(51) Int. Cl. H04S 7/00; H04S 3/00

(52) U.S. Cl. CPC H04S 7/302; H04S 3/008; H04S 2400/01; H04S 2400/11

(57) ABSTRACT

The disclosure relates to a method of processing signals for sound reproduction in a reproduction environment comprising one or more listening zones, the method comprising: at alignment logic of a system for sound reproduction: receiving a master input signal for reproduction or for use as a reference signal in each of the one or more listening zones; receiving one or more zone-specific input signals each for reproduction in a respective one of the one or more listening zones; obtaining, from the master input signal, an aligned master signal; and aligning, with respect to the aligned master signal, the one or more zone-specific input signals to yield one or more respective aligned zone-specific signals; and at output logic of the system for sound reproduction: receiving the aligned master signal and receiving the one or more aligned zone-specific signals; processing the aligned master signal to yield a processed master signal; and processing the one or more aligned zone-specific signals to yield one or more processed zone-specific signals.

### RELATED APPLICATIONS

This application claims priority under 35 U.S.C. § 119 or 365 to Great Britain, Application No. 2413459.5, filed Sep. 12, 2024. The entire teachings of the above application are incorporated herein by reference.

### TECHNICAL FIELD

The disclosure relates to a method of processing signals for sound reproduction, and a system for sound reproduction configured to perform the method. More particularly, the disclosure relates to a method of processing signals for sound reproduction in a reproduction environment comprising one or more listening zones.

### BACKGROUND

One or more loudspeakers may be used to reproduce input audio signals in a reproduction environment. In some cases it is desirable to be able to reproduce a plurality of different output audio signals at a plurality of control points, such as the ears of one or more listeners. The input audio signals may be processed using a variety of filters and/or signal processing algorithms, depending on the type of audio signal to be reproduced and the nature of the listening environment. In some other cases, it may be desirable to reproduce the same plurality of signals at a plurality of control points and still be desirable to align each of these signals before reproduction.

However, audio signal processing may be computationally expensive. Additionally, dedicated processing systems may need to be designed to perform the audio signal processing, as existing systems may not natively support the desired signal processing algorithms.

Furthermore, crosstalk may occur when the different output audio signals are intended for reproduction at a plurality of control points in a same reproduction environment, i.e., the control points are not physically separated. Traditionally, optimisation of sound reproduction for such different output audio signals is only performed for a single set of positions in space resulting in a single set of “sweet spots” where the loudspeaker signals combine correctly; this may yield substandard sound reproduction quality for the listeners who are outside of said set of sweet spots.

One or more aspects of the invention of the present application are set out in the claims.

### BRIEF DESCRIPTION OF THE DRAWINGS

The disclosure will now be described in more detail in connection with a number of exemplary embodiments shown in the accompanying drawings, in which:

FIG. 1 shows a schematic representation of a use case of some implementations of the present disclosure;

FIG. 2A shows a block diagram of a system for sound reproduction according to some implementations of the present disclosure;

FIG. 2B shows an alternative block diagram of the system of FIG. 2A;

FIG. 2C shows a block diagram of an alternative system for sound reproduction according to some implementations of the present disclosure;

FIG. 3 shows a block diagram of a master sub-system for sound reproduction according to some implementations of the present disclosure;

FIG. 4A shows a block diagram of a global sub-system for sound reproduction according to some implementations of the present disclosure;

FIG. 4B shows a block diagram of a global sub-system for sound reproduction according to some implementations alternative to those of FIG. 4A;

FIG. 5 shows a block diagram of local sub-systems for sound reproduction according to some implementations of the present disclosure;

FIGS. 6A-C are respective parts of a flowchart of a method for sound reproduction which may be performed using the system for sound reproduction according to the present disclosure;

FIG. 7A shows a schematic representation of a first use case of some implementations of the present disclosure;

FIG. 7B shows a schematic representation of a second use case of some implementations of the present disclosure; and

FIG. 8 shows a block diagram of an exemplary apparatus for implementing any of the methods described herein.

### DETAILED DESCRIPTION

In overview, the disclosure relates to a method of processing signals (e.g., an audio track) for sound reproduction in a reproduction environment comprising one or more listening zones (e.g., a vehicle/cinema with a zone for each passenger/viewer). The method comprises steps which are performed at an alignment logic (e.g., a first processor to align different audio signals with respect to each other) and steps which are performed at an output logic (e.g., a second processor to prepare output signals for one or more loudspeakers). This allows the method to be implemented without using a system designed specifically to perform both signal alignment and signal processing; instead existing systems which natively support only one or the other of the desired signal alignment or processing algorithms may be used. The alignment and output logic are the parts of a system for sound reproduction.

At the alignment logic (or ‘alignment stage’), a master input signal and one or more zone-specific input signals are received. The master signal is for reproduction or for use as a reference signal in each of the plurality of listening zones (e.g., in an entire cinema, i.e., for all seats), while the one or more zone-specific input signals are each for reproduction in a respective one of the plurality of listening zones (e.g., one signal for each seat of the cinema). This separation between master signal and zone-specific signals allows the signal processing to be less expensive both computationally and in terms of required hardware, as the master and zone-specific signals can be processed by different hardware with different functionality and different processing algorithms tailored to the requirements of each signal; without this separation, signals are all processed by a same hardware which needs to have all the required functionality and perform all the required algorithms. From the master input signal, an aligned master signal is obtained, and the one or more zone-specific input signals are aligned with respect to the aligned master signal, to yield one or more respective aligned zone-specific signals. Aligning the signals may involve performing a time alignment of the signals with respect to each other and/or an equalisation or gain adjustment.

At the output logic (or ‘reproduction stage’), the aligned master signal and the one or more aligned zone-specific signals are received and processed (e.g., by applying filters or audio processing algorithms), thus yielding a processed master signal and one or more processed zone-specific signals. These processed signals may then be output to one or more loudspeakers. This arrangement allows an optimisation of sound reproduction to be performed for different output signals and, optionally, for multiple corresponding positions in space, such that the loudspeakers' signals combine correctly and result in a better listening experience for listeners. This processing may be for any number of listeners (from a few seats of a car to a large number of seats of a cinema).

### A Use Case and its Challenges

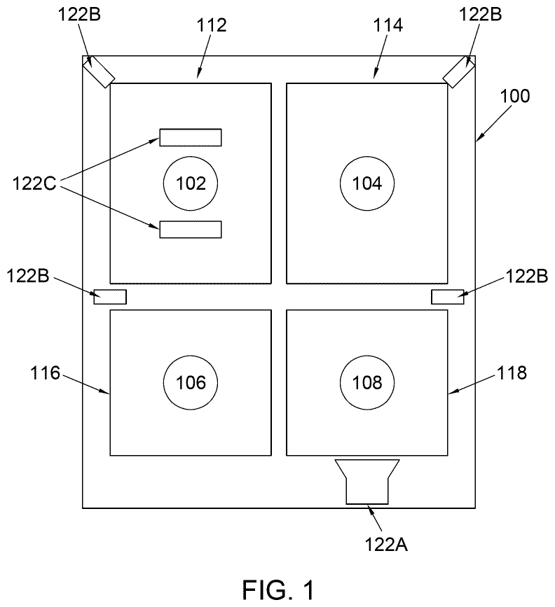

So that the disclosure that follows can be better understood, a use case for the method and system disclosed herein is described below. Referring to FIG. 1, one may wish to reproduce sound for a plurality of listeners 102, 104, 106, 108 in a plurality of listening zones 112, 114, 116, 118 of a reproduction environment 100 such as a vehicle. It may be desirable to provide each listener 102, 104, 106, 108 with audio tailored to them, e.g., which differs depending on their position in the reproduction environment, their personal preferences, or their choice of completely different audio content. Note that this different audio tailored to them may include the same content for each user but with user-specific personalisation, or may include a different input signal for each position/listener.

One or more loudspeakers 122 and audio (digital) signal processing may be used to achieve this goal. More specifically, Sound Field Control (SFC) algorithms may be used, whereby several sound inputs are used together to generate spatially-tailored audio for the listeners 102, 104, 106, 108 by tailoring the reproduced audio to listening zones 112, 114, 116, 118 within the shared reproduction environment 100. In other words, an aim of a system using SFC algorithms is to reproduce different sounds in different regions within a shared space, such as the reproduction environment 100, without the need for physical barriers between its regions, i.e., listening zones 112, 114, 116, 118. Multiple reproduction techniques (for example in different frequency ranges) and/or reproduction systems (for example different sets of loudspeakers) may be used.

One challenge is to provide effective isolation between listening zones 112, 114, 116, 118 across the whole audio bandwidth, i.e., for low frequencies (where the sound field in the space to be controlled is dominated by modal behaviour), for mid-frequencies (where techniques such as loudspeaker array beamforming are effective), and for high frequencies (where the directivity of individual loudspeakers is a significant contributor to the spatial distribution of sound in the target space). Each of the frequency regimes described above potentially require different and conflicting signal processing schemes and loudspeaker geometries, thereby complicating the implementation of a single system which seeks to operate across the entire audio bandwidth.

Therefore, the reproduction environment 100 may be provisioned with one or more loudspeakers 122 comprising a subwoofer 122A, a loudspeaker array 122B for all listeners (e.g., the standard, built-in loudspeakers of the vehicle), and additional loudspeakers 122C for each listener in each listening zone 112, 114, 116, 118 (e.g., additional loudspeakers in a headrest of each listener). Then, the subwoofer 122A may be configured to reproduce a master signal spanning a low frequency range for all listening zones 112, 114, 116, 118, the loudspeaker array 122B may be configured to reproduce a global signal spanning a mid-frequency range for all listening zones 112, 114, 116, 118, and the loudspeakers 122C in each zone 112, 114, 116, 118 may be configured to reproduce a zone-specific signal spanning a high frequency range for that particular zone 112, 114, 116, 118. Said master, global, and zone-specific signals can thus be processed separately using signal processing schemes (e.g., different SFC algorithms) appropriate to each of them.

A further challenge is maintaining a correspondence between the listening zones and the listeners, such that the sound is delivered accurately (e.g., without colouration) to a listening zone while minimising crosstalk from other listening zones, especially in the case where listeners move within and/or between zones.

Therefore, a system for sound reproduction in the reproduction environment 100 may track and operate based on the positions (e.g., head positions) of the listeners 102, 104, 106, 108 in the plurality of listening zones 112, 114, 116, 118. For example, when multiple people share a space and want to hear the same media, a multi-listener spatial audio reproduction system can use personalised Head Related Transfer Functions and other user-specific information to tailor the sound heard by each listener to their own position, head orientation, anatomy, hearing acuity, and tonal preferences. While each listener hears what is superficially the same media (and may hear common sounds from a subwoofer or other master system), each listener also receives a personalised audio feed.

Yet another challenge is that, for high quality reproduction of sound across the entire audio bandwidth (i.e., in all the different frequency ranges) and/or to use different processing and reproduction schemes to create the listening zones (in different regions in space), it is often necessary to use multiple loudspeaker drivers, whose output in the listening zones must be aligned, e.g., time-delayed or equalised.

Therefore, the system for sound reproduction in the reproduction environment 100 may align audio input signals before they are output to the loudspeakers 122. This may involve delaying in time, adjusting the volume of, and/or equalising (e.g., adjusting the magnitude and/or phase at specific frequencies of) audio input signals, e.g., of input master, global, and zone-specific signals as described above. Additionally, this may involve dynamically updating the alignment parameters based on the positions of the listeners 102, 104, 106, 108 in the plurality of listening zones 112, 114, 116, 118. This alignment can assist perceptually in preserving directional cues for listeners 102, 104, 106, 108 and in improving the perception of transient events in the reproduced audio signals.

### Logic and Sub-Systems of the System for Sound Reproduction

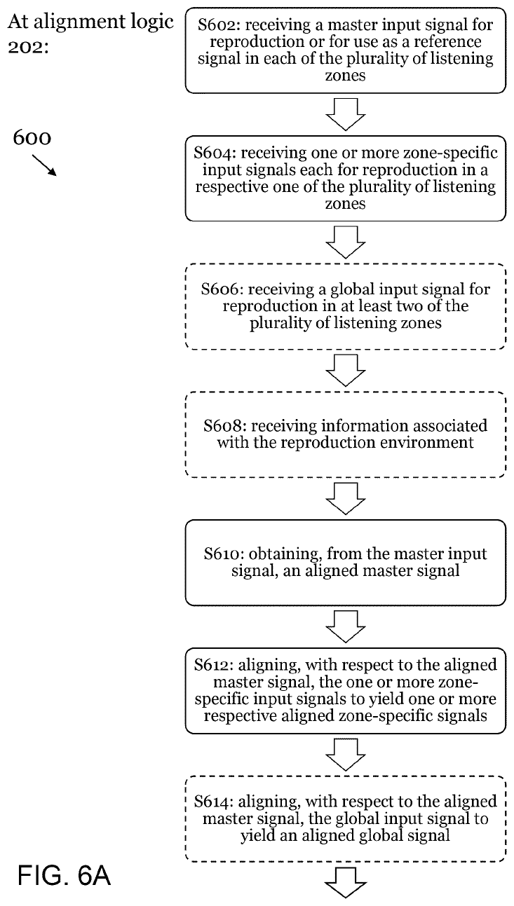

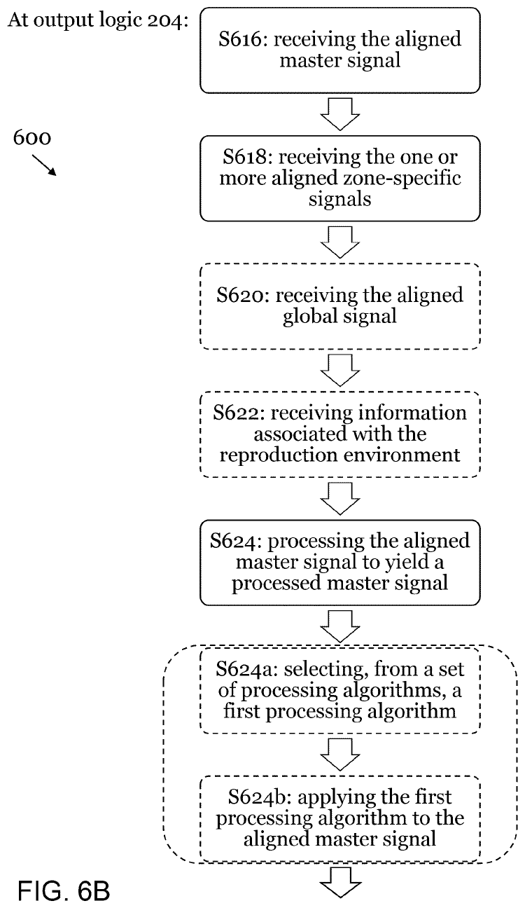

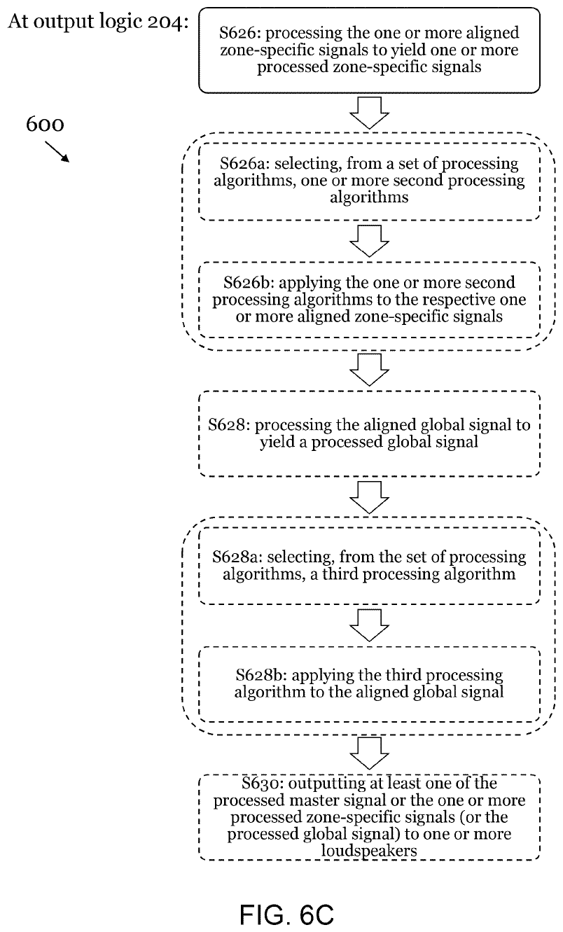

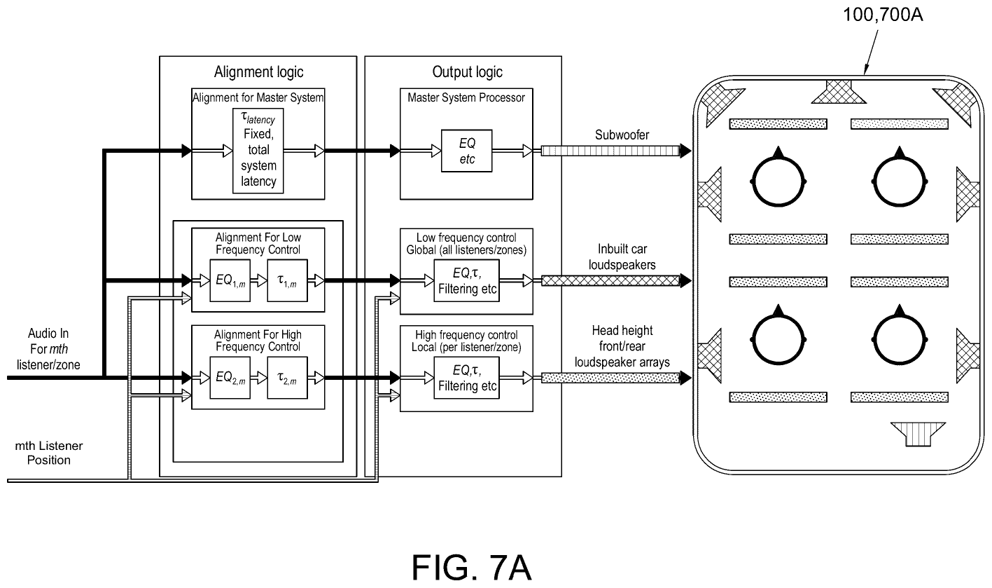

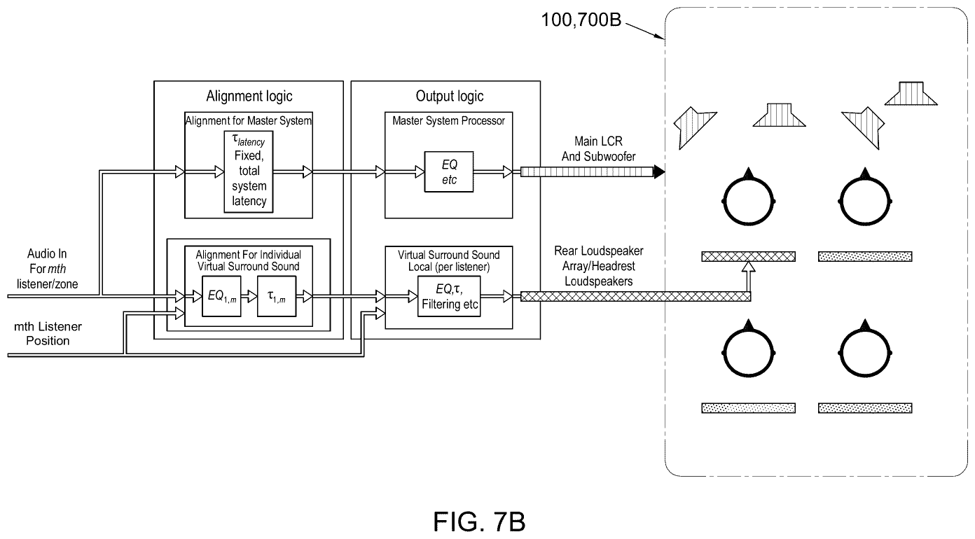

Generalising from the above and other potential use cases (see, e.g., FIG. 7A and FIG. 7B), the present disclosure provides a system for sound reproduction 200 (and related method of processing signals for sound reproduction 600, as described below with reference to FIGS. 6A-C). The system is configured such that it is possible to combine independent user/listener tracking, sound zoning, and dynamic alignment to deliver high quality spatial audio and/or different audio content to multiple users simultaneously. The system can also combine listener tracking and dynamic alignment to deliver high quality spatial audio to a single listener where multiple systems are used, for example with each system working in a different frequency range.

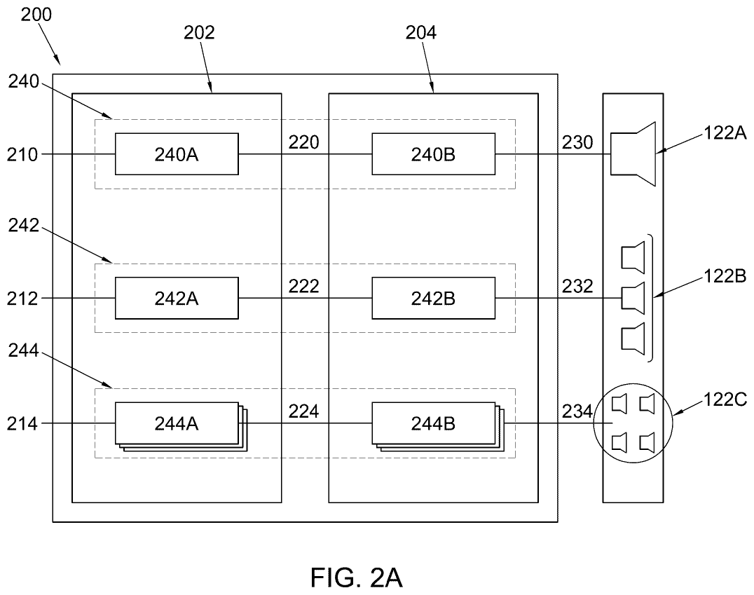

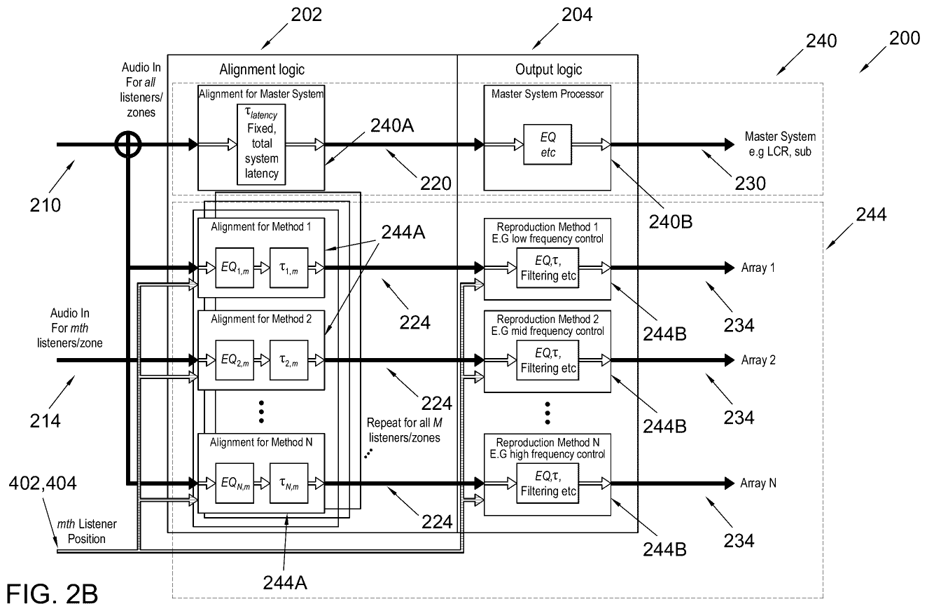

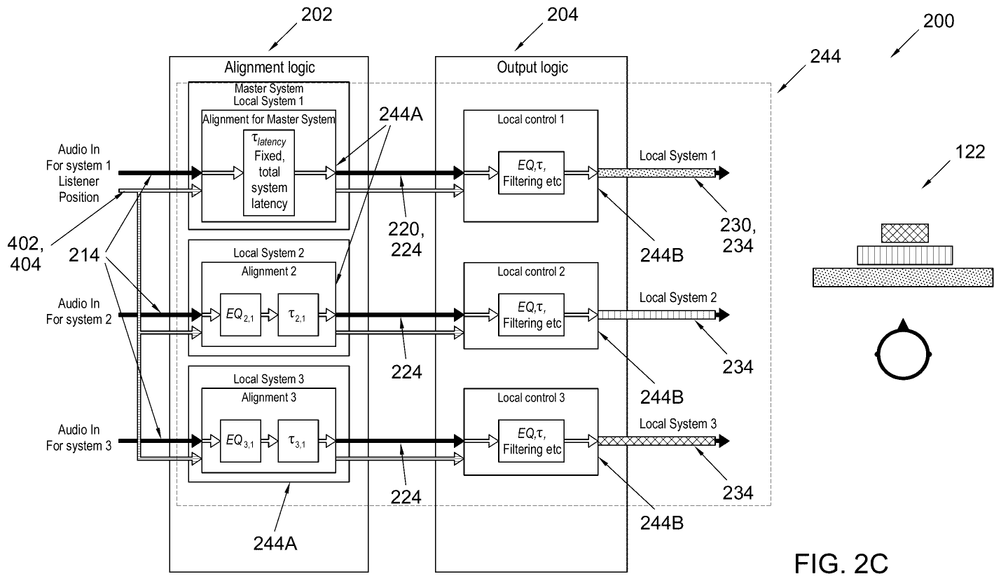

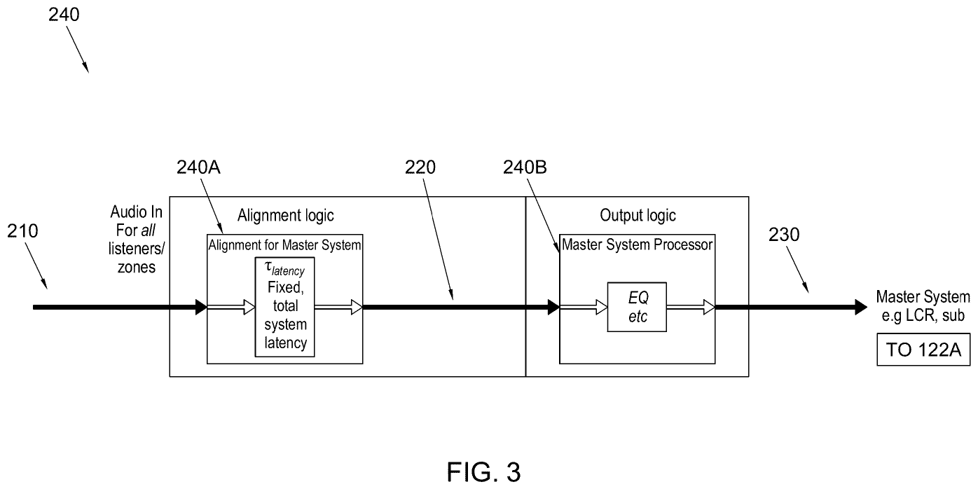

Referring to FIGS. 2A-B, the system for sound reproduction 200 comprises alignment logic 202 and output logic 204. Alignment logic 202 is configured to receive input signals 210, 212, 214 for reproduction and align them as explained in more detail below. Output logic 204 is configured to receive aligned signals 220, 222, 224 for reproduction and process them (e.g., using SFC algorithms) as explained in more detail below. The output logic may further be configured to output at least one of the processed signals 230, 232, 234 to one or more loudspeakers 122 communicatively coupled to the system for sound reproduction 200. This arrangement allows sound alignment to be performed by hardware that is different and/or independent from the hardware processing the signal (e.g., using SFC algorithms).

Similarly to the use case described above in relation to FIG. 1, the system for sound reproduction 200 is configured to receive a master input signal 210 and one or more zone-specific input signals 214. In some implementations, a global input signal 212 may also be received. Accordingly, in some implementations, the system 200 may be configured such that master input signal 210 is received and the master aligned signal 220 is obtained/processed by a master sub-system 240 of the system 200, the master sub-system comprising master alignment logic 240A and master output logic 240B, and such that the one or more zone-specific input signals 214 are received/aligned and the one or more aligned zone-specific signals 224 are processed by a respective zone-specific sub-system 244 of the system 200, the respective zone-specific sub-system comprising zone-specific alignment logic 244A and zone-specific output logic 244B. This arrangement allows each of the master signal 210 and the one or more zone-specific signals 214 to be processed by different and/or independent hardware.

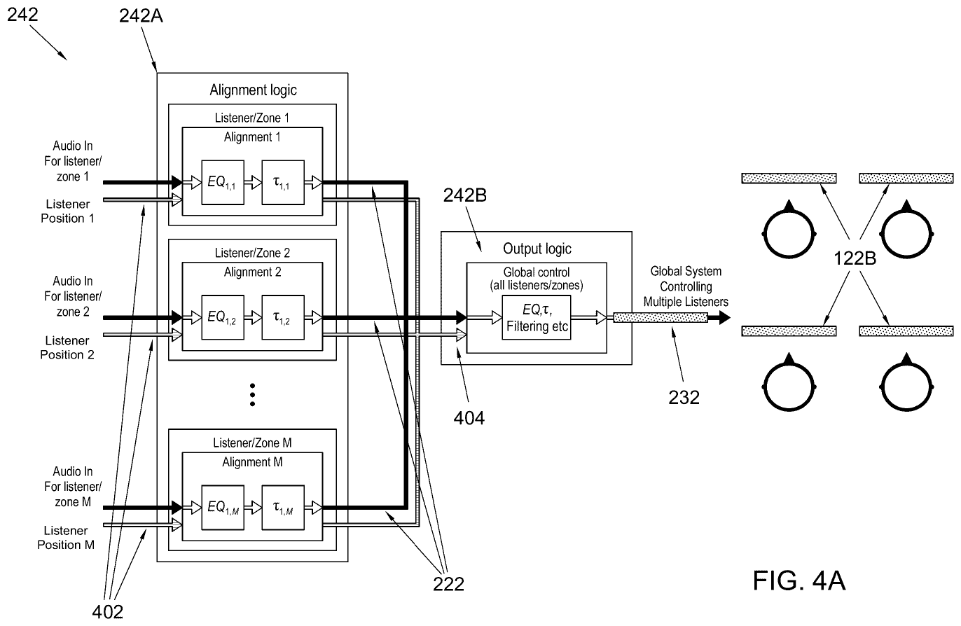

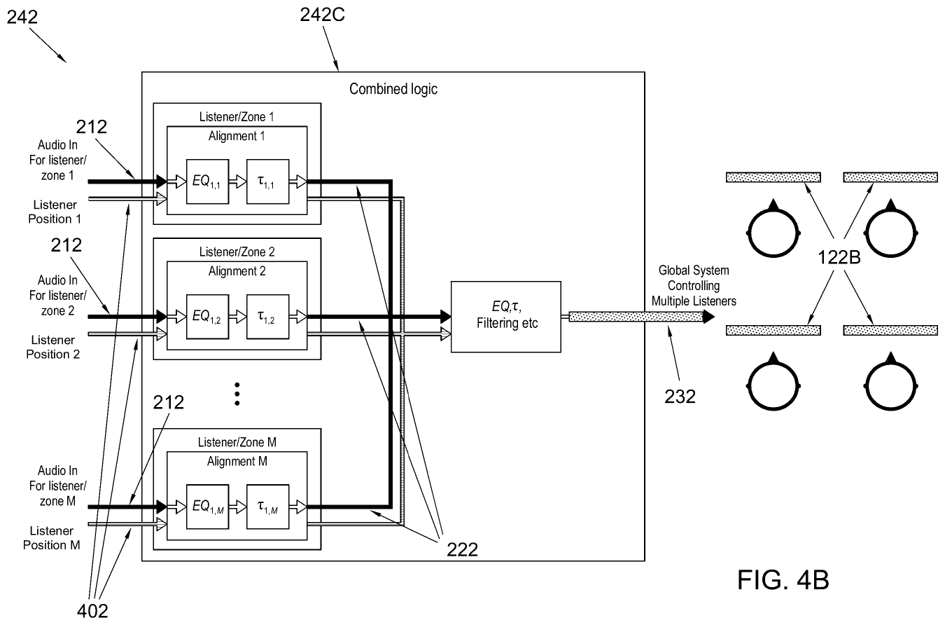

If a global input signal 212 is also received, the global input signal 212 is received/aligned and the aligned global signal 222 is processed by a global sub-system 242 of the system 200, the global sub-system comprising global alignment logic 242A and global output logic 242B or by a combined global alignment and output logic 242C (shown later in FIG. 4B), so that it can be processed by different and/or independent hardware than the master signal 210 and the one or more zone-specific signals 214.

Thus, the sound reproduction system 200 can handle the entire signal chain including signal processing, computation/modification/filtering of the input audio, then a set of loudspeaker signals that will lead to the reproduction of the desired pressure in the listening zones.

A master sub-system 240 is a reproduction system that is, in many but not all implementations, common to all zones (i.e., it is a global system), which all other systems use as a reference for the alignment of signals. A sub-system 244, 242 of the reproduction system 200 may be local or zone-specific (i.e., only a single listener/listening zone is controlled by the sub-system 244), or global where multiple listeners/listening zones are controlled by the sub-system 242. A given loudspeaker 122 can belong to both a global and a local control sub-system (e.g., all loudspeakers are used at low frequencies for all zones, whereas a smaller subset 122C of the closest loudspeakers to a zone is used at high frequencies). The SFC methods used by each sub-system may comprise a number of approaches, for example, inverse filtering (including measured and/or modelled transfer functions), acoustic contrast control (including measured and/or modelled transfer functions), amplitude panning, delay panning, etc.

In the case that the master sub-system is not a global system (i.e., it is zone-specific), the leakage from the master sub-system may instead be used as a reference for the alignment of signals. For example, referring to FIG. 2C, the system for sound reproduction 200 may not comprise a master sub-system 240 common to all zones. Instead, the system 200 may comprise a plurality of zone-specific sub-systems 244, one of which is elevated to the role of master system (as explained in more detail below).

The alignment logic 202 is a signal processing block before the output logic 204, which performs an alignment to ensure the audio at the control points due to the said reproduction system is aligned in a specific manner. For example, the alignment may be such that the audio from the reproduction system and the master system arrive at the same time with the same relative volume and equalisation. The alignment logic thus may provide a time delay and a gain (frequency-independent volume adjustment) and more general equalisation through filtering (for example magnitude and phase adjustment per frequency).

User tracking can be integrated into any part of the system to provide consistent sound for each listener. Additionally, the use of head tracking avoids having to detune or compromise the system to work across a wide area—the system places effort only in controlling the locations of the listeners. Both model-based and measurement-based control schemes allow for the forward-prediction of the sound field at any measured or modelled location. This capability, along with knowledge of the tracked user position(s) can be used to dynamically align the arrival of sounds from the different loudspeakers 122 present in the space. For example, in a vehicle, these may be a subwoofer 122A, door woofers 122B, headrest speakers 122C, and sun-visor speakers.

### Master System

Referring to FIG. 3, a master sub-system 240 of a system for sound reproduction 200 is now described in more detail. The master sub-system comprises master alignment logic 240A and master output logic 240B; these logics may be the same as other alignment logic or output logic described herein (e.g., zone-specific alignment logic 244A and zone-specific output logic 244B), or may be implemented using dedicated hardware. The master sub-system 240 is configured, at the alignment logic 240A, to receive a master input signal 210 and to obtain an aligned master signal 220; for example, the master sub-system 240 may be configured to delay the master input signal 210 based on a total system latency of the system for sound reproduction 200. Signals of other sub-systems (e.g., a zone-specific sub-system 244) of the system for sound reproduction 200 may be aligned with respect to the aligned master signal 220. The master sub-system 240 is configured, at the output logic 240B, to receive an aligned master signal 220 and process it (e.g., equalise) to obtain a processed master signal 230. The output logic 240B may further be configured to output the processed master signal 230 to one or more loudspeakers 122 communicatively coupled to the system for sound reproduction 200, e.g., a subwoofer 122A. A zone-specific sub-system 244 of the reproduction system 200 may be elevated to the role of master sub-system 240; in other words, a zone-specific sub-system 244 may be configured to provide the functionality of the master system 240 (an example is shown in FIG. 2C). If a zone-specific sub-system 244 (e.g., aiming to control a single listener zone only) is elevated to the role of master sub-system, the alignment may be performed based on the sound leakage of said zone-specific sub-system to the other listening zones.

### Global System

Two possible implementations of a global sub-system 242 of a system for sound reproduction 200 are described below. As explained above, this sub-system need only be present if a global input signal 212 is also received. Additionally, a global sub-system 242 can be elevated to the role of master sub-system 240; in other words, the master system 240 may be configured to also provide the functionality of a global sub-system.

Referring to FIG. 4A, in a first implementation, a SFC process for multiple listeners/listening zones 112, 114, 116, 118 may be performed by a global alignment logic 242A and a global reproduction logic 242B. These logics may be the same as other alignment logic or output logic described herein (e.g., master alignment logic 240A and master output logic 240B), or may be implemented using dedicated hardware. The global processed signal 232 intended to be delivered to the multiple listening zones may be first equalised and/or delayed, with respect to an aligned master signal 220, by the global alignment logic 242A before being sent to the output logic 242B for processing (e.g., by using SFC algorithms). This implementation may simplify the process of designing SFC filters, as a generic control algorithm (which does not natively provide alignment to a master system or between listeners) can be used without modification.

Alternatively, as shown in FIG. 4B, in a second implementation, the alignment logic 242A is integrated together with the output logic 242B (i.e., there is a combined global alignment and output logic 242C). The advantage of this implementation is that audio latency can be minimised: the common delay between the modelling delay in the SFC filters and the explicit alignment delays can be removed, and the knowledge of the entire alignment logic 242A can be used to optimise the processing approach at output logic 242B.

In both the first and second implementations, the global sub-system 242 may be configured, at the alignment logic 242A, to receive a global input signal 212 and to align it, with respect to an aligned master signal 220, to obtain an aligned global signal 222. The global sub-system 242 may be configured, at the output logic 242B, to receive an aligned global signal 222 and process it to obtain a processed global signal 232. The output logic 242B may further be configured to output the processed global signal 232 to one or more loudspeakers 122 communicatively coupled to the system for sound reproduction 200, e.g., an array of loudspeakers 122B. Moreover, the global sub-system may also be configured to receive information 402, 404 associated with a reproduction environment 100 at the global alignment logic 242A and/or at the global reproduction logic 242B, or at the combined logic 242C.

### Zone-Specific Sub-Systems

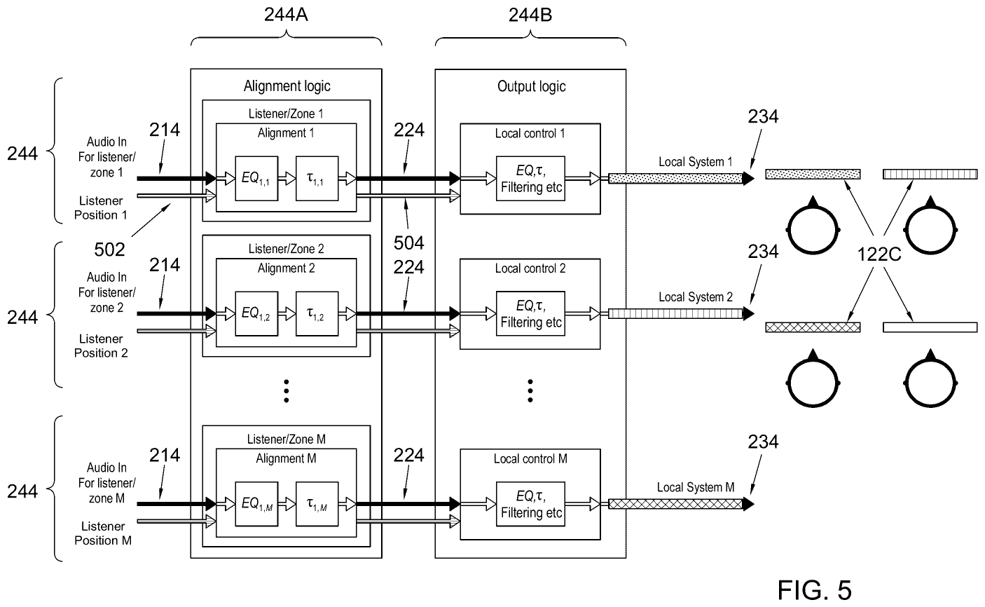

Referring to FIG. 5, a zone-specific sub-system 244 of a system for sound reproduction 200 is now described in more detail. However, it should be noted that the system for sound reproduction 200 may comprise more than one zone-specific sub-system 244, e.g., depending on how many zone-specific input signals 214 are received; for example, there may be one zone-specific sub-system 244 for each listener/listening zone 112, 114, 116, 118. The zone-specific sub-system 244 comprises zone-specific alignment logic 244A and zone-specific output logic 244B; these logics may be the same as other alignment logic or output logic described herein (e.g., master alignment logic 240A and master output logic 240B), or may be implemented using dedicated hardware.

The zone-specific sub-system 244 may be configured, at the alignment logic 244A, to receive a zone-specific input signal 214 and to align it, with respect to an aligned master signal 220, to obtain an aligned zone-specific signal 224. The zone-specific sub-system 244 may be configured, at the output logic 244B, to receive an aligned zone-specific signal 224 and process it to obtain a processed zone-specific signal 234. The output logic 244B may further be configured to output the processed zone-specific signal 234 to one or more loudspeakers 122 communicatively coupled to the system for sound reproduction 200, e.g., zone-specific loudspeakers 122C. Moreover, the zone-specific sub-system 244 may also be configured to receive information 502, 504 associated with a reproduction environment 100 at the zone-specific alignment logic 244A and/or at the zone-specific reproduction logic 244B.

Thus, using one or more zone-specific sub-systems 244, a set of local (i.e., zone-specific) SFC algorithms can work independently in a shared space such as reproduction environment 100 (comprising listening zones 112, 114, 116, 118). In this case, each zone-specific sub-system for each zone may be configured to be fully independent of the others and may be supplied only with (position) information 502, 504 about a single listener, i.e., there is no attempt from one zone-specific sub-system to control the audio reproduced at the position of another user. Moreover, in order to provide a high-quality aligned audio signal with respect to the master sub-system 240, independent alignment for each zone-specific sub-system can be performed at the alignment logic 244A.

### Method for Sound Reproduction

Referring to FIGS. 6A-C, a method 600 of processing signals for sound reproduction in a reproduction environment 100 (e.g., the environment 100 of FIG. 1) comprising a plurality of listening zones 112, 114, 116, 118 may be performed by the system for sound reproduction 200 described above in relation to FIGS. 2A-C (and in more detail in FIG. 3, FIG. 4A, FIG. 4B, and FIG. 5). Steps S602 to S614 of method 600 may be performed at alignment logic 202 of the system for sound reproduction 200, and steps S616 to S630 of method 600 may be performed at output logic 204 of the system for sound reproduction 200.

At step S602, the method comprises receiving a master input signal 210 for reproduction or for use as a reference signal in each of the plurality of listening zones 112, 114, 116, 118.

At step S604, the method comprises receiving one or more zone-specific input signals 214 each for reproduction in a respective one (e.g., listening zone 112) of the plurality of listening zones 112, 114, 116, 118.

Optionally, at step S606, the method may comprise receiving a global input signal 212 for reproduction in at least two (e.g., listening zones 112, 114) of the plurality of listening zones 112, 114, 116, 118.

Optionally, at step S608, the method may comprise receiving information 402, 502 associated with the reproduction environment 100. The information 402, 502 associated with the reproduction environment 100 may comprise at least one of: information associated with each of the plurality of listening zones 112, 114, 116, 118, for example one or more positions (e.g., head positions) of one or more respective listeners 102, 104, 106, 108, each listener being associated with a respective one (e.g., listening zone 112) of the plurality of listening zones; a temperature of the reproduction environment 100; a number of listeners in the reproduction environment 100; an indication of background noise conditions inside the reproduction environment 100; or an indication of external noise conditions outside the reproduction environment 100.

At step S610, the method comprises obtaining, from the master input signal 210, an aligned master signal 220.

At step S612, the method comprises aligning, with respect to the aligned master signal 220, the one or more zone-specific input signals 214 to yield one or more respective aligned zone-specific signals 224.

Optionally, at least one of obtaining the aligned master signal or aligning the one or more zone-specific input signals may be based on the information 402, 502 associated with the reproduction environment 100 and received at step S608. For example, obtaining the aligned master signal 220 may comprise aligning the master input signal 210 based on information 402 associated with each of the plurality of listening zones 112, 114, 116, 118 and aligning the one or more zone-specific input signals 214 may be based on information 502 associated with the respective one of the plurality of listening zones 112, 114, 116, 118.

Optionally, if a global input signal 212 is received (at step S606), at step S614, the method may comprise aligning, with respect to the aligned master signal 220, the global input signal 212 to yield an aligned global signal 222. Aligning the global input signal 212 may be based on the information 402 associated with the reproduction environment 100 received at step S608, for example information associated with the at least two of the plurality of listening zones 112, 114, 116, 118.

Obtaining the aligned master signal 220 may comprise performing at least one of a time alignment or an equalisation of the master input signal 210. Aligning the one or more zone-specific input signals 214 may similarly comprise performing at least one of a time alignment or an equalisation of the one or more zone-specific input signals 214. If there is a global input signal 212, aligning the global input signal 212 may comprise performing at least one of a time alignment or an equalisation of the global input signal 212. At least one of the time alignment or the equalisation may be based on the information 402, 502 associated with the reproduction environment 100 received at step S608.

The aligned master signal and the one or more aligned zone-specific signals can then be provided to the output logic 204.

Optionally, the aligned global signal can also be provided to the output logic 204.

At step S616, the method comprises receiving the aligned master signal 220.

At step S618, the method comprises receiving the one or more aligned zone-specific signals 224.

Optionally, if a global input signal 212 is received and aligned (at steps S606 and S614), at step S620, the method may comprise receiving the aligned global signal 222.

Optionally, at step S622, the method may comprise receiving information 404, 504 associated with the reproduction environment 100. The information 404, 504 associated with the reproduction environment 100 may comprise at least one of: information associated with each of the plurality of listening zones 112, 114, 116, 118, for example one or more positions (e.g., head positions) of one or more respective listeners 102, 104, 106, 108, each listener being associated with a respective one (e.g., listening zone 112) of the plurality of listening zones; a temperature of the reproduction environment 100; a number of listeners in the reproduction environment 100; an indication of background noise conditions inside the reproduction environment 100; or an indication of external noise conditions outside the reproduction environment 100. The information 404, 504 may be received from the alignment logic 202 and/or may be the same as the information 402, 502 received at the alignment logic 202.

At step S624, the method comprises processing the aligned master signal 220 to yield a processed master signal 230. Processing the aligned master signal 220 may comprise selecting S624a, from a set of processing algorithms, a first processing algorithm to apply to the aligned master signal 220, and applying S624b the first processing algorithm to the aligned master signal 220.

At step S626, the method comprises processing the one or more aligned zone-specific signals 224 to yield one or more processed zone-specific signals 234. Processing the one or more aligned zone-specific signals 224 may comprise selecting S626a, from a set of processing algorithms, one or more second processing algorithms each to apply to a respective one of the one or more aligned zone-specific signals 224, and applying the one or more second processing algorithms to the respective one or more aligned zone-specific signals 224. At least one of processing the aligned master signal 220 or processing the one or more aligned zone-specific signals 224 may be based on the information 404, 504 associated with the reproduction environment 100 received at step S622.

Optionally, if an aligned global signal 222 is received, at step S628, the method may comprise processing the aligned global signal 222 to yield a processed global signal 232. Processing the aligned global signal 222 may comprise selecting S628a, from the set of processing algorithms, a third processing algorithm to apply to the aligned global signal 222, and applying S628b the third processing algorithm to the aligned global signal 222. Processing the aligned global signal 222 may be based on the information 404 associated with the reproduction environment 100 received at step S622.

As explained in relation to FIGS. 2A-C, it may be beneficial to be able to provide the alignment logic 202 and the output logic 204 by means of different, independent hardware. In this case, at least one of obtaining S610 the aligned master signal 220 or aligning S612 the one or more zone-specific input signals 214 is not performed at the output logic 204, and/or at least one of processing S624 the aligned master signal 220 or processing S626 the one or more aligned zone-specific signals 224 is not performed at the alignment logic 202. Additionally, if there is a global input signal 212, aligning S614 the global input signal 212 is not performed at the output logic 204, and/or processing S628 the aligned global signal 222 is not performed at the alignment logic 202. This allows the selecting steps S624a, S626a, S628a described above to be performed based on which algorithm is most suitable for the signal that is being processed and using the capabilities of hardware specially provisioned for the processing of the signal, independently from selections in relation to other signals and independently from the capabilities (or lack thereof) of the hardware processing said other signals. The same applies to the obtaining/aligning steps S610, S612, S614.

The processing algorithms that may be selected in steps S624a, S626a, S628a may comprise at least one sound field control (SFC) algorithm; for example the SFC algorithm may be an inverse filtering algorithm, an acoustic contrast control algorithm, or a pressure matching algorithm. Any of the first, second, and third processing algorithms may be the same algorithm as, or may be a different algorithm to, another of the first, second, and third processing algorithms; this may depend on, for example, what kind of processing is most appropriate in a particular implementation/for a particular signal and/or on the capabilities of the hardware processing that signal. Thus, each of the processed master 230, global 232, and zone-specific 242 signals can be tailored in an optimal way to its intended listener(s) 102, 104, 106, 108.

Optionally, at step S630, the method may comprise outputting at least one of the processed master signal 230 or the one or more processed zone-specific signals 234 to one or more loudspeakers 122 communicatively coupled to the system for sound reproduction 200. For example, the processed master signal 230 may be output to a subwoofer 122A and the one or more processed zone-specific signals 234 may be output to one or more loudspeakers 122C, each loudspeaker 122C providing sound reproduction for one of the plurality of listening zones 112, 114, 116, 118. If there is a processed global signal 232, step S630 may also comprise outputting the processed global signal 232 to the one or more loudspeakers 122 communicatively coupled to the system for sound reproduction 200, for example to a loudspeaker array 122B.

As explained above, different frequency regimes potentially require different and conflicting signal processing schemes and loudspeaker geometries. In some implementations, the processed master signal 230 may span a first frequency range (e.g., low frequencies or a frequency range reproducible through a subwoofer 122A) and the one or more processed zone-specific signals 234 may span a second frequency range (e.g., high frequencies). For example, the spanned ranges may be such that a lower limit frequency of the first frequency range is lower than a lower limit frequency of the second frequency range, or an upper limit frequency of the second frequency range is higher than an upper limit frequency of the first frequency range. If there is a processed global signal 232, the global processed signal 232 may span a third frequency range (e.g., mid-frequencies). For example, the spanned ranges may be such that a lower limit frequency of the third frequency range is higher than a lower limit frequency of the first frequency range and lower than a lower limit frequency of the second frequency range, or an upper limit frequency of the third frequency range is higher than an upper limit frequency of the first frequency range and lower than an upper limit frequency of the second frequency range. However, those skilled in the art will recognise that any number of frequency ranges may be defined and that a frequency range or ranges (or no particular frequency range) may be assigned in an entirely different way to each of the sub-system described herein. A limit frequency may be a frequency at which the signal amplitude or power reaches a predetermined fraction (less than 1) of its peak value, e.g., a 3 dB frequency at which the power has dropped to half of its peak value.

Those skilled in the art will recognise that the method 600 may be repeated any number of times to process new input signals, denoted as ‘new 210’, ‘new 212’, and ‘new 214’. For example, the method 600 may be continuously executed so that an audio track can be reproduced in full. Accordingly, the method 600 may further comprise repeating the receiving S602 of a master input signal 210, the receiving S604 of one or more zone-specific input signals 214, the obtaining S610 of an aligned master signal 220, and the aligning S612 of the one or more zone-specific input signals 214 with a new master input signal ‘new 210’ and new one or more zone-specific input signals ‘new 214’. The method may also further comprise repeating the receiving S616 of the aligned master signal 220 and the receiving S618 of the one or more aligned zone-specific signals 224, the processing S624 the aligned master signal 220, and the processing S626 the one or more aligned zone-specific signals 224 with a new aligned master signal ‘new 220’, obtained from the new master input signal ‘new 210’, and new one or more aligned zone-specific signals ‘new 224’, obtained from the new one or more zone-specific input signals ‘new 214’.

Similarly, new information ‘new 402’, ‘new 404’, ‘new 502’, ‘new 504’ associated with the reproduction environment 100 may be received; for example, as the system 200 tracks the listeners 102, 104, 106, 108, an updated position of said listeners may be received by the system 200. Accordingly, the method 600 may optionally further comprise: repeating the receiving S608 information 402, 502 associated with the reproduction environment 100 (so that at least one of obtaining the new aligned master signal ‘new 220’ or aligning the new one or more zone-specific input signals ‘new 214’ is based on new information ‘new 402’, ‘new 502’ associated with the reproduction environment 100) or repeating the receiving S22 of information 404, 504 associated with the reproduction environment 100 (so that at least one of processing the new aligned master signal ‘new 220’ or processing the new one or more aligned zone-specific signals ‘new 224’ is based on new information ‘new 404’, ‘new 504’ associated with the reproduction environment 100).

### Alignment

Alignment steps S610, S612, and S614 of method 600 described above yield aligned master, global, and zone-specific signals 220, 222, 224. Further optional details of these alignment steps are now described.

Alignment may comprise any of the following operations:
Time delays;
Equalisation/volume adjustment, which may be frequency independent (constant gain at all frequencies) or frequency dependent (e.g., through filtering, adjusting the magnitude and/or phase at each frequency). The equalisation may for example:
   Compensate for the reproduction system's response within the room for the specific user position (response varies as a combination of loudspeaker-user position across the room);
   Ensure appropriate combination of different reproduction system processing methods operating in different frequency regions; and/or
   Ensure appropriate combination of different loudspeakers used in different reproduction systems operating in different frequency regions.

The present disclosure proposes for example that (multi-point) alignment may be used across the listening zone(s) and the different reproduction methods may be employed by the system as follows:
Dynamic Alignment: The alignment is not restricted to a single position and is dynamic to, e.g., the user position, the number of users/zones, the number of different reproduction systems;
Alignment across zones: Align the reproduced pressure at the reproduction control points in different sound zones;
Alignment of different reproduction systems: Align the reproduced pressure in one given listening zone where different subsets of reproduction loudspeakers with unique control methods are used in certain regions (for example, different control methods in different frequency bands);
Improved reproduction based on the alignment: Knowledge of the required alignment can be used when defining the reproduction methods for more efficient or effective sound zone reproduction.

Approaches for alignment of audio systems are known to a person skilled in the art. In general, an array of loudspeakers is situated within a space. An acoustic measurement or a physical measurement (positions of the loudspeakers) is performed. From these measurements, the values required for an alignment stage are extracted (for example, delays, volume adjustment or equalisation for each loudspeaker). The alignment may only be performed for one given listener position, as the absolute values for exact alignment vary as soon as the listener position is changed. Alternatively, multiple positions may be measured and average alignment values can be used, which is a trade-off between performance and generalisation. If listener tracking is employed, the alignment may be dynamically changed in time based on the current listener position. For example, a dynamic alignment approach is considered which updates the delay alignment values for each individual loudspeaker for a multichannel surround sound system (covering one overall system) using a video camera for listener tracking. Such systems have traditionally been utilised for surround sound content, for example where the individual loudspeaker alignment values are updated for 5.1 system (thus remaining alignment of the loudspeakers within one given system) dynamically based on the position estimates where the listener position estimate is given by wireless tracking of a listener personal device. For multiple listeners, the problem is more complex. For example, a dynamic alignment approach is considered for multiple listeners, where image processing is used to estimate the density of a crowd in large format venues such as concerts or cinema, then the audio system is adjusted to reproduce optimally for this approximate area. It should be noted that this may be an adjustment for a single system and not necessarily considering sound field reproduction techniques.

Alignment is beneficial as:
The different sound field control processes (the different reproduction systems) may yield different length filters with the main peak occurring at a different time (different modelling delays).
The different sound field control processes may use different sampling rates.
The different sound field control processes may have different latencies, for example due to requiring different signal processing blocks (e.g., gain lines, delay lines, FIR filtering, IIR filtering).
The speakers are all different distances from the listener.
It may be important from a sound quality perspective to preserve interaural time difference cues. These are interpreted by the brain to localise sound sources within a reproduced sound.
It improves the perception of transient events in the reproduced audio programme.
Different reproduction systems may output at different volumes and require gain equalisation, this may also vary with distance away from the systems.
The characteristics of the acoustic space impact the output of a loudspeaker at the user position, thus requiring equalisation (e.g., room equalisation).
Different reproduction systems may use different loudspeakers which require equalisation for consistent response considering the combination of all the systems at the user position.

Alignment methods can be used at the tuning stage of the audio system, to make sure that all the different control schemes are aligned in a nominal position. Furthermore, as users in normal situations do move, it is important to dynamically change and adjust the values of the different alignment elements of the various control schemes to make sure that the alignment is preserved with different user positions to the nominal ones. This, in practice, happens constantly, so the alignment values can be changed constantly. These alignment values can be calculated according to the instantaneous user positions which can be estimated using a user tracking or position sensor.

### Output

Processing steps S624, S626, and S628 of method 600 described above yield processed master, global, and zone-specific signals 230, 232, 234. Further optional details of these processing steps are now described.

Generally, approaches to sound field control assume prior knowledge of the transfer function responses in the space, that is the acoustical transmission path from each loudspeaker to each given control (reproduction) point. A listening zone or user reproduction position may be represented by one or more control points (e.g., a control point at each ear). Obtaining these transfer functions can be done through a significant number of measurements including implementing a look-up table and interpolation scheme, through utilising simpler analytical/numerical models that approximate the real-life system, or some combination of the two.

The reproduction methods may include:
Inverse filtering (least squares pressure matching/crosstalk cancellation/transaural), which for listener-adaptive reproduction requires a computationally expensive real-time matrix inversion.
Acoustic contrast control, which also requires computationally expensive real-time matrix inversion and solving eigenvalue problems.
Object-based source panning based on varying the amplitude and/or intensity and/or time that the object-based signal is sent to specific loudspeakers.
Some methods which use a combined approach that include elements of acoustic contrast control and pressure matching.
Some approaches which do not require inversion of a full transfer function matrix (between every source and every receiver). Better robustness to errors can be achieved by assigning a subset of the control sources to a subset of the control points, e.g., for an in-car control problem, only using headrest loudspeakers nearest to each listener to control the sound for that listener. Depending on the level of independence between the loudspeakers and control points, this may allow for the use of sparse matrix solving techniques.
Some approaches which do not require matrix inversion but implement adaptive filters (NLMS, RLS, Affine projections, etc.).

Those skilled in the art will recognise that the present disclosure is not limited to any one individual reproduction approach, listed above or otherwise. Instead, any approach in the overall category of reproduction approaches described above, that is sound field control (SFC) algorithms, may be used.

FIG. 2B, for example, shows how audio signals (solid arrows) and listener position signals (dashed arrows) are used in the “alignment stage” and “output stage” of the proposed signal processing scheme. In the alignment stage, the signals to be reproduced by each sound field control method are delayed and equalised to compensate for:
the propagation delay caused by the (variable) positions of the listeners;
any delay differences between signal processing methods;
any equalisation/volume differences between signal processing methods;
any equalisation/volume differences due to the acoustics of the space;
any equalisation/volume differences due to the different loudspeakers used in each system;
any equalisation/volume differences due to characteristics personalised to each given listener, for example their specific head shape.

The pre-aligned acoustic signals from the “alignment stage” are passed to the “output stage”, which completes the necessary signal processing to solve the desired sound field control problem. The outputs of the “output stage” are electrical loudspeaker signals. Final alignment for all signals is achieved when the acoustical loudspeaker output signals combine at the position of each listener. The “Master System” is optional and provides the main signal that other (potentially user-specific/personalised) signals are aligned to, for example a subwoofer. In the absence of an obvious Master System any given reproduction system may be elevated to the Master.

### Example Use Cases

Referring to FIG. 7A, an example of the above general approach is shown for an in-vehicle 700A scenario. In this case, the “Master system” is also a global system and is heard by all listeners, a single-channel subwoofer. Two further subsystems covering two different frequency ranges are aligned to the master system.

In this example, the built-in car loudspeakers (filled with dashed lines) are configured as a “global” system, i.e., the control scheme responsible for driving these loudspeakers is aware of the position of all listeners in the vehicle and aims to control the pressure at all of these positions. The head-height loudspeaker arrays (shown with a dotted pattern) can either be configured to operate similarly, as a global system, or as four independent “local control” systems, i.e. the control process that creates the loudspeaker signals for the head-height loudspeaker arrays receives information only and/or environmental parameters about the position of one listener, and controls the pressure for said listener. In this example the designation of the different master/sub-systems is such that different optimal methods may be used in different frequency ranges.

Referring to FIG. 7B, a similar example for a cinema 700B system is presented. In this example, the “Master system” is also a global system, a main (LCR+Sub) loudspeaker system in the room heard by all listeners. Each individual listener also hears nearfield and surround effects from a set of loudspeakers mounted in their own headrest. In this instance, only local (i.e., individual per-listener) sound field control is provided by each set of headrest speakers. Note that thus the alignment of each local headrest system varies based on its position in the room (and the position of the listener if listener tracking is employed) with respect to the Master system. In this example the design of the sub-systems is such that different optimal methods may be used in different frequency ranges. In this example the designation of the different master/sub-systems is such that different optimal methods may be used in different spatial regions (the Master system reproducing content from the far field frontal region, and the sub-systems reproducing surrounding and nearfield regions).

It should be noted that this system may be scaled from a single to multiple listeners with no change to the design of the signal processing chain (only repeating the chain per listener) because the SFC approach is local.

### Examples of the Disclosure

There is disclosed a method of processing signals for sound reproduction in a reproduction environment comprising a one or more listening zones, the method comprising:
at alignment logic of a system for sound reproduction: receiving a master input signal for reproduction or for use as a reference signal in each of the one or more listening zones; receiving one or more zone-specific input signals each for reproduction in a respective one of the one or more listening zones; obtaining, from the master input signal, an aligned master signal; and aligning, with respect to the aligned master signal, the one or more zone-specific input signals to yield one or more respective aligned zone-specific signals; and
at output logic of the system for sound reproduction: receiving the aligned master signal and receiving the one or more aligned zone-specific signals; processing the aligned master signal to yield a processed master signal; and processing the one or more aligned zone-specific signals to yield one or more processed zone-specific signals.

Optionally, the method further comprises, at the alignment logic: receiving information associated with the reproduction environment. At least one of obtaining the aligned master signal or aligning the one or more zone-specific input signals is based on the information associated with the reproduction environment.

Optionally, obtaining the aligned master signal comprises aligning the master input signal based on information associated with each of the one or more listening zones; and aligning the one or more zone-specific input signals is based on information associated with the respective one of the one or more listening zones.

Optionally, the method further comprises, at the output logic: receiving information associated with the reproduction environment. At least one of processing the aligned master signal or processing the one or more aligned zone-specific signals is based on the information associated with the reproduction environment.

Optionally, the information associated with the reproduction environment comprises at least one of: information associated with each of the one or more listening zones, optionally one or more positions of one or more respective listeners each associated with a respective one of the one or more listening zones, the one or more positions further optionally being head positions; information associated with each of a plurality of loudspeakers, optionally one or more positions and/or orientations of one or more loudspeakers; a temperature of the reproduction environment; a number of listeners in the reproduction environment; an indication of background noise conditions inside the reproduction environment; or an indication of external noise conditions outside the reproduction environment.

Optionally, at least one of obtaining the aligned master signal or aligning the one or more zone-specific input signals respectively comprises performing at least one of a time alignment, an equalisation, or a gain adjustment of the master input signal or the one or more zone-specific input signals.

Optionally, at least one of the time alignment or the equalisation is based on the information associated with the reproduction environment.

Optionally, processing the aligned master signal comprises selecting, from a set of processing algorithms, a first processing algorithm to apply to the aligned master signal, and applying the first processing algorithm to the aligned master signal; and processing the one or more aligned zone-specific signals comprises selecting, from a set of processing algorithms, one or more second processing algorithms each to apply to a respective one of the one or more aligned zone-specific signals, and applying the one or more second processing algorithms to the respective one or more aligned zone-specific signals.

Optionally, at least one of obtaining the aligned master signal or aligning the one or more zone-specific input signals is not performed at the output logic.

Optionally, at least one of processing the aligned master signal or processing the one or more aligned zone-specific signals is not performed at the alignment logic.

Optionally, the processing algorithms comprise at least one sound field control algorithm.

Optionally, the at least one sound field control algorithm is an inverse filtering algorithm, an acoustic contrast control algorithm, or a pressure matching algorithm.

Optionally, the method further comprises, at the output logic: outputting at least one of the processed master signal or the one or more processed zone-specific signals to one or more loudspeakers.

Optionally, the processed master signal spans a first frequency range (optionally, reproducible through a subwoofer); the one or more processed zone-specific signals span a second frequency range; and at least one of: a lower limit frequency of the first frequency range is lower than a lower limit frequency of the second frequency range; or an upper limit frequency of the second frequency range is higher than an upper limit frequency of the first frequency range.

Optionally, the method further comprises:
at the alignment logic: receiving a global input signal for reproduction in at least one of the one or more listening zones; aligning, with respect to the aligned master signal, the global input signal to yield an aligned global signal;
at the output logic: receiving the aligned global signal; processing the aligned global signal to yield a processed global signal; optionally, outputting the processed global signal to one or more loudspeakers.

Optionally, aligning the global input signal is based on the information associated with the reproduction environment.

Optionally, aligning the global input signal is based on information associated with the at least one of the one or more listening zones.

Optionally, processing the aligned global signal is based on the information associated with the reproduction environment.

Optionally, aligning the global input signal comprises performing at least one of a time alignment, an equalisation or a gain adjustment of the global input signal.

Optionally, at least one of the time alignment, the equalisation, or the gain adjustment is based on the information associated with the reproduction environment.

Optionally, processing the aligned global signal comprises selecting, from the set of processing algorithms, a third processing algorithm to apply to the aligned global signal, and applying the third processing algorithm to the aligned global signal.

Optionally, aligning the global input signal is not performed at the output logic.

Optionally, processing the aligned global signal is not performed at the alignment logic. Optionally, the global processed signal spans a third frequency range.

Optionally, a lower limit frequency of the third frequency range is higher than a lower limit frequency of the first frequency range and lower than a lower limit frequency of the second frequency range.

Optionally, an upper limit frequency of the third frequency range is higher than an upper limit frequency of the first frequency range and lower than an upper limit frequency of the second frequency range.

Optionally, the method further comprises:
repeating the receiving a master input signal, the receiving one or more zone-specific input signals, the obtaining an aligned master signal, and the aligning the one or more zone-specific input signals to yield one or more respective aligned zone-specific signals with a new master input signal and one or more new zone-specific input signals; and
repeating the receiving the aligned master signal and the receiving the one or more aligned zone-specific signals, the processing the aligned master signal, and the processing the one or more aligned zone-specific signals with a new aligned master signal, obtained from the new master input signal, and one or more new aligned zone-specific signals, obtained from the one or more new zone-specific input signals.

Optionally, the method further comprises:
receiving, at the alignment logic, new information associated with the reproduction environment, and at least one of obtaining the new aligned master signal or aligning the new one or more zone-specific input signals is based on the new information associated with the reproduction environment; or
receiving, at the output logic, new information associated with the reproduction environment, and at least one of processing the new aligned master signal or processing the one or more new aligned zone-specific signals is based on the new information associated with the reproduction environment.

There is also disclosed one or more computer-readable media comprising instructions which, when executed by a plurality of processors of a system for sound reproduction, cause the system to perform the method of any of the above examples, or the method 600, or any combination thereof.

There is also provided a system for sound reproduction configured to perform the method of any of the above examples, or the method 600, or any combination thereof.

Optionally, the alignment logic is implemented by a first processor, and the output logic is implemented by a second processor, and the system thus comprises the first processor and the second processor.

Optionally, the master input signal is received and the master aligned signal is obtained/processed by a master sub-system of the system, the master sub-system comprising master alignment logic and master output logic.

Optionally, the one or more zone-specific input signals are received/aligned and the one or more aligned zone-specific signals are processed by a respective zone-specific sub-system of the system, the respective zone-specific sub-system comprising zone-specific alignment logic and zone-specific output logic.

Optionally, the global input signal is received/aligned and the aligned global signal is processed by a global sub-system of the system, the global sub-system comprising global alignment logic and global output logic.

Optionally, the global input signal is received/aligned and the aligned global signal is processed by a global sub-system of the system, the global sub-system comprising a combined global alignment and output logic.

There is also disclosed a reproduction environment comprising the system.

Optionally, the reproduction environment is at least one of a vehicle or a cinema.

### Computer Implementation

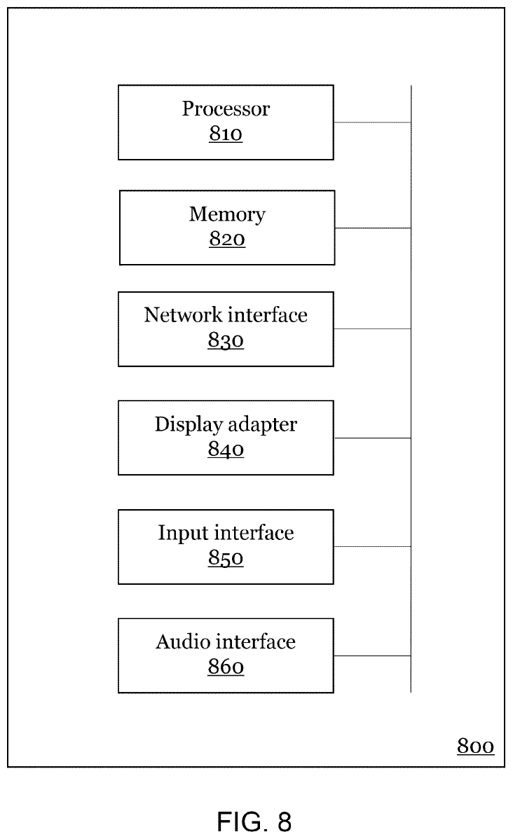

A block diagram of an exemplary apparatus 800 for implementing any of the methods described herein, or any portion thereof, such as method 600, is shown in FIG. 8. The exemplary apparatus 800, or a portion thereof including at least a processor, may, for example, be used to implement any of alignment logic 202, output logic 204, master alignment logic 240A, master output logic 240B, global alignment logic 242A, global output logic 242B, combined global alignment and output logic 242C, zone-specific alignment logic 244A, or zone-specific output logic 244B.

The apparatus 800 comprises a processor 810 (e.g., a digital signal processor, or a multipurpose processor) arranged to execute computer-readable instructions as may be provided to the apparatus 800 via one or more of a memory 820, a network interface 830, or an input interface 850.

The memory 820, for example a random-access memory (RAM), is arranged to be able to retrieve, store, and provide to the processor 810, instructions and data that have been stored in the memory 820. The network interface 830 is arranged to enable the processor 810 to communicate with a communications network, such as the Internet. The input interface 850 is arranged to receive user inputs provided via an input device (not shown) such as a mouse, a keyboard, or a touchscreen. The processor 810 may further be coupled to a display adapter 840, which is in turn coupled to a display device (not shown). The processor 810 may further be coupled to an audio interface 860 which may be used to output audio signals to one or more audio devices, such as a loudspeaker array (or ‘array of loudspeakers’, or ‘sound reproduction device’) 122C. The audio interface 860 may comprise a digital-to-analog converter (DAC) (not shown), e.g., for use with audio devices with analog input(s).

The approaches described herein may be embodied on a computer-readable medium. Said computer-readable medium may be a non-transitory computer-readable medium. The computer-readable medium carries computer-readable instructions arranged for execution upon a processor so as to make the processor carry out any or all of the methods described herein.

The term “computer-readable medium” as used herein refers to any medium that stores data and/or instructions for causing a processor to operate in a specific manner. Such storage medium may comprise non-volatile media and/or volatile media. Non-volatile media may include, for example, optical or magnetic disks. Volatile media may include dynamic memory. Exemplary forms of storage medium include, a floppy disk, a flexible disk, a hard disk, a solid state drive, a magnetic tape, or any other magnetic data storage medium, a CD-ROM, any other optical data storage medium, any physical medium with one or more patterns of holes, a RAM, a PROM, an EPROM, a FLASH-EPROM, NVRAM, and any other memory chip or cartridge.

### INTERPRETATION

Section titles are provided above to ease understanding of the disclosure, and are not to be construed as limiting the scope of the disclosure.

It is to be understood that the above description is intended to be illustrative, and not restrictive. Many other implementations will be apparent to those of skill in the art upon reading and understanding the above description. Although the present disclosure has been described with reference to specific example implementations, it will be recognised that the disclosure is not limited to the implementations described, but can be practised with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A method of processing signals for sound reproduction in a reproduction environment comprising one or more listening zones, the method comprising:
at alignment logic of a system for sound reproduction:
receiving a master input signal for reproduction or for use as a reference signal in each of the one or more listening zones;
receiving one or more zone-specific input signals each for reproduction in a respective one of the one or more listening zones;
receiving information associated with the reproduction environment, wherein the information associated with the reproduction environment comprises one or more positions of one or more respective listeners each associated with a respective one of the one or more listening zones;
obtaining, from the master input signal, an aligned master signal; and
aligning, with respect to the aligned master signal, the one or more zone-specific input signals to yield one or more respective aligned zone-specific signals, wherein at least one of obtaining the aligned master signal or aligning the one or more zone-specific input signals is based on the information associated with the reproduction environment; and
at output logic of the system for sound reproduction:
receiving the aligned master signal and receiving the one or more aligned zone-specific signals;
processing the aligned master signal to yield a processed master signal; and
processing the one or more aligned zone-specific signals to yield one or more processed zone-specific signals.

2. The method of claim 1, wherein:
obtaining the aligned master signal comprises aligning the master input signal based on information associated with each of the one or more of listening zones; and
aligning the one or more zone-specific input signals is based on information associated with the respective one of the one or more of listening zones.

3. The method of claim 1, further comprising, at the output logic:
receiving information associated with the reproduction environment,
wherein at least one of processing the aligned master signal or processing the one or more aligned zone-specific signals is based on the information associated with the reproduction environment.

4. The method of claim 1, wherein
the information associated with the reproduction environment further comprises at least one of:
information associated with each of a plurality of loudspeakers, optionally one or more positions and/or orientations of one or more loudspeakers;
a temperature of the reproduction environment;
a number of listeners in the reproduction environment;
an indication of background noise conditions inside the reproduction environment; or
an indication of external noise conditions outside the reproduction environment, and/or
wherein the one or more positions of the one or more respective listeners are head positions.

5. The method of claim 1, wherein at least one of obtaining the aligned master signal or aligning the one or more zone-specific input signals respectively comprises performing at least one of a time alignment, an equalisation, or a gain adjustment of the master input signal or the one or more zone-specific input signals,
optionally wherein at least one of the time alignment, the equalisation, or gain adjustment is based on the information associated with the reproduction environment.

6. The method of claim 1, wherein:
processing the aligned master signal comprises selecting, from a set of processing algorithms, a first processing algorithm to apply to the aligned master signal, and applying the first processing algorithm to the aligned master signal; and
processing the one or more aligned zone-specific signals comprises selecting, from a set of processing algorithms, one or more second processing algorithms each to apply to a respective one of the one or more aligned zone-specific signals, and applying the one or more second processing algorithms to the respective one or more aligned zone-specific signals.

7. The method of claim 6, wherein at least one of:
at least one of obtaining the aligned master signal or aligning the one or more zone-specific input signals is not performed at the output logic;
at least one of processing the aligned master signal or processing the one or more aligned zone-specific signals is not performed at the alignment logic; or
the processing algorithms comprise at least one sound field control algorithm, and optionally the at least one sound field control algorithm is an inverse filtering algorithm, an acoustic contrast control algorithm, or a pressure matching algorithm.

8. The method of claim 1, further comprising, at the output logic:
outputting at least one of the processed master signal or the one or more processed zone-specific signals to one or more loudspeakers.

9. The method of claim 1, wherein:
the processed master signal spans a first frequency range, optionally reproducible through a subwoofer;
the one or more processed zone-specific signals span a second frequency range; and
at least one of:
a lower limit frequency of the first frequency range is lower than a lower limit frequency of the second frequency range; or
an upper limit frequency of the second frequency range is higher than an upper limit frequency of the first frequency range.

10. The method of claim 1, further comprising:
at the alignment logic:
receiving a global input signal for reproduction in at least one of the one or more listening zones; and
aligning, with respect to the aligned master signal, the global input signal to yield an aligned global signal; and
at the output logic:
receiving the aligned global signal; and
processing the aligned global signal to yield a processed global signal;
optionally, outputting the processed global signal to one or more loudspeakers.

11. The method of claim 10, wherein at least one of:
aligning the global input signal is based on the information associated with the reproduction environment, optionally wherein aligning the global input signal is based on information associated with the at least one of the one or more listening zones; or
the method further comprises, receiving, at the output logic, information associated with the reproduction environment, at least one of processing the aligned master signal or processing the one or more aligned zone-specific signals being based on the information associated with the reproduction environment, and processing the aligned global signal being based on the information associated with the reproduction environment.

12. The method of claim 10, wherein aligning the global input signal comprises performing at least one of a time alignment, an equalisation, or a gain adjustment of the global input signal,
optionally wherein at least one of the time alignment, the equalisation, or the gain adjustment is based on the information associated with the reproduction environment.

13. The method of claim 10, wherein:
processing the aligned master signal comprises selecting, from a set of processing algorithms, a first processing algorithm to apply to the aligned master signal, and applying the first processing algorithm to the aligned master signal; and
processing the one or more aligned zone-specific signals comprises selecting, from a set of processing algorithms, one or more second processing algorithms each to apply to a respective one of the one or more aligned zone-specific signals, and applying the one or more second processing algorithms to the respective one or more aligned zone-specific signals,
wherein processing the aligned global signal comprises selecting, from the set of processing algorithms, a third processing algorithm to apply to the aligned global signal, and applying the third processing algorithm to the aligned global signal,
optionally wherein at least one of: aligning the global input signal is not performed at the output logic, or processing the aligned global signal is not performed at the alignment logic.

14. The method of claim 10, wherein:
the processed master signal spans a first frequency range, optionally reproducible through a subwoofer;
the one or more processed zone-specific signals span a second frequency range; and
at least one of:
a lower limit frequency of the first frequency range is lower than a lower limit frequency of the second frequency range; or
an upper limit frequency of the second frequency range is higher than an upper limit frequency of the first frequency range,
wherein the global processed signal spans a third frequency range, wherein at least one of:
a lower limit frequency of the third frequency range is higher than a lower limit frequency of the first frequency range and lower than a lower limit frequency of the second frequency range; or
an upper limit frequency of the third frequency range is higher than an upper limit frequency of the first frequency range and lower than an upper limit frequency of the second frequency range.

15. The method of claim 1, further comprising:
repeating the receiving a master input signal, the receiving one or more zone-specific input signals, the obtaining an aligned master signal, and the aligning the one or more zone-specific input signals to yield one or more respective aligned zone-specific signals with a new master input signal and one or more new zone-specific input signals; and
repeating the receiving the aligned master signal and the receiving the one or more aligned zone-specific signals, the processing the aligned master signal, and the processing the one or more aligned zone-specific signals with a new aligned master signal, obtained from the new master input signal, and one or more new aligned zone-specific signals, obtained from the one or more new zone-specific input signals,
optionally, wherein:
the method further comprises receiving, at the alignment logic, new information associated with the reproduction environment, wherein at least one of obtaining the new aligned master signal or aligning the new one or more zone-specific input signals is based on the new information associated with the reproduction environment; or
the information associated with the reproduction environment further comprises at least one of:
information associated with each of a plurality of loudspeakers, optionally one or more positions and/or orientations of one or more loudspeakers;
a temperature of the reproduction environment;
a number of listeners in the reproduction environment;
an indication of background noise conditions inside the reproduction environment; or
an indication of external noise conditions outside the reproduction environment, and
the method further comprises receiving, at the output logic, new information associated with the reproduction environment, wherein at least one of processing the new aligned master signal or processing the one or more new aligned zone-specific signals is based on the new information associated with the reproduction environment.

16. One or more non-transitory computer-readable media comprising instructions which, when executed by a plurality of processors of a system for sound reproduction, cause the system to perform a method of processing signals for sound reproduction in a reproduction environment comprising one or more listening zones, the method comprising:
at alignment logic of a system for sound reproduction:
receiving a master input signal for reproduction or for use as a reference signal in each of the one or more listening zones;
receiving one or more zone-specific input signals each for reproduction in a respective one of the one or more listening zones;
receiving information associated with the reproduction environment, wherein the information associated with the reproduction environment comprises one or more positions of one or more respective listeners each associated with a respective one of the one or more listening zones;
obtaining, from the master input signal, an aligned master signal; and
aligning, with respect to the aligned master signal, the one or more zone-specific input signals to yield one or more respective aligned zone-specific signals, wherein at least one of obtaining the aligned master signal or aligning the one or more zone-specific input signals is based on the information associated with the reproduction environment; and
at output logic of the system for sound reproduction:
receiving the aligned master signal and receiving the one or more aligned zone-specific signals;
processing the aligned master signal to yield a processed master signal; and
processing the one or more aligned zone-specific signals to yield one or more processed zone-specific signals.

17. A system for sound reproduction comprising one or more processors configured to perform a method of processing signals for sound reproduction in a reproduction environment comprising one or more listening zones, the method comprising:
at alignment logic of a system for sound reproduction:
receiving a master input signal for reproduction or for use as a reference signal in each of the one or more listening zones;
receiving one or more zone-specific input signals each for reproduction in a respective one of the one or more listening zones;
receiving information associated with the reproduction environment, wherein the information associated with the reproduction environment comprises one or more positions of one or more respective listeners each associated with a respective one of the one or more listening zones;
obtaining, from the master input signal, an aligned master signal; and
aligning, with respect to the aligned master signal, the one or more zone-specific input signals to yield one or more respective aligned zone-specific signals, wherein at least one of obtaining the aligned master signal or aligning the one or more zone-specific input signals is based on the information associated with the reproduction environment; and
at output logic of the system for sound reproduction:
receiving the aligned master signal and receiving the one or more aligned zone-specific signals;
processing the aligned master signal to yield a processed master signal; and
processing the one or more aligned zone-specific signals to yield one or more processed zone-specific signals.

18. The system of claim 17, wherein:
the master input signal is received and the master aligned signal is obtained/processed by a master sub-system of the system, the master sub-system comprising master alignment logic and master output logic; and
the one or more zone-specific input signals are received/aligned and the one or more aligned zone-specific signals are processed by a respective zone-specific sub-system of the system, the respective zone-specific sub-system comprising zone-specific alignment logic and zone-specific output logic.

19. The system of claim 17, wherein the method further comprises:
at the alignment logic:
receiving a global input signal for reproduction in at least one of the one or more listening zones; and
aligning, with respect to the aligned master signal, the global input signal to yield an aligned global signal; and
at the output logic:
receiving the aligned global signal; and
processing the aligned global signal to yield a processed global signal;
optionally, outputting the processed global signal to one or more loudspeakers, and wherein:
the global input signal is received/aligned and the aligned global signal is processed by a global sub-system of the system, the global sub-system comprising global alignment logic and global output logic; or
the global input signal is received/aligned and the aligned global signal is processed by a global sub-system of the system, the global sub-system comprising a combined global alignment and output logic.

20. The system of claim 17 in a reproduction environment, optionally wherein the reproduction environment is at least one of a vehicle or a cinema.
